(19) United States
(12) Patent Application Publication
(10) Pub. No.: US 2024/0172720 A1
(43) Pub. Date: May 30, 2024

(54) AUTOMATICALLY CLOSING PET FOOD SYSTEM

(71) Applicant: Brendon Tylar Burke, London (CA)

(72) Inventor: Brendon Tylar Burke, London (CA)

(21) Appl. No.: 18/513,837

(22) Filed: Nov. 20, 2023

Related U.S. Application Data
(60) Provisional application No. 63/428,078, filed on Nov. 27, 2022.

(51) Int. Cl. A01K 5/01; A01K 5/02; A01K 11/00

(52) U.S. Cl. CPC A01K 5/0142; A01K 5/025; A01K 11/006

(57) ABSTRACT

An automatically closing pet food system comprises a transmitter for attachment to a pet and a food bowl including a receiver for receiving a signal from the transmitter when the pet is within a predetermined distance of the food bowl. Upon receipt of the signal, a mechanical iris closure on the food bowl opens, providing access to food within the food bowl. Once the pet moves past the predetermined distance, the mechanical iris closes, inhibiting access to food within the bowl. This provides the ability to keep multiple pet foods separate.

### CROSS-REFERENCE TO RELATED APPLICATION

The present application is related to and claims priority to U.S. Provisional Patent Application No. 63,428/078 filed Nov. 27, 2022, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of pet accessories of existing art and more specifically relates to a pet food dish with automatic closure.

### RELATED ART

Pet ownership is ever increasing across the globe, with dogs and cats being amongst the most popular pets. It is estimated that more than half of the global population have a pet at home, with 33% of households globally having a dog and 23% having a cat. It is not surprising then that many households choose to adopt more than one pet—whether of the same species or a mix of different animals.

Whilst owning multiple pets can be a joyous and enriching experience for animals and their owner, a challenge encountered by numerous pet owners with multiple animals is that of food. This is particularly true if pets in the home require different diets, one (or more) of the pets are dominant over other pets, one (or more) of the pets overeat, etc. For example, a puppy may need to eat a particular diet that is different to an older dog in the home, but the older dog may consistently eat the puppy's food, which can result in weight gain for the older dog and can leave the puppy with little to no food. In another example, whilst cats and dogs typically have distinct diets, there may be instances where a dog regularly consumes a cat's food, or vice versa. As such, a suitable solution is desired.

### SUMMARY OF THE INVENTION

In view of the foregoing disadvantages inherent in the known pet food bowl art, the present disclosure provides a novel automatically closing pet food system. The general purpose of the present disclosure, which will be described subsequently in greater detail, is to provide a pet food bowl that prevents unauthorized access to pet food by keeping the pet food bowl closed until an authorized pet is within a predetermined distance, thus providing owners with the ability to keep multiple pet foods separate.

An automatically closing pet food system is disclosed herein. According to one or more embodiments, the automatically closing pet food system may include at least one transmitter and a food bowl. The at least one transmitter may be configured for attachment to at least one authorized pet and the food bowl may include a main body, a receiver and a mechanical iris. The main body may include an opening providing access to an interior of the main body, which is configured to store an amount of pet food. The receiver may be disposed in the main body and configured to receive a signal from the transmitter when within a predetermined distance.

The mechanical iris may be disposed at a top of the main body and including an actuator configured to move the mechanical iris between a closed position and an open position: the closed position covering the opening and inhibiting access to the amount of pet food; the open position uncovering the opening and providing access to the amount of pet food. The actuator may be in communication with the receiver such that receipt of the signal from the transmitter causes the actuator to move the mechanical iris into the open position to provide access to the pet food for the authorized pet and movement of the transmitter past the predetermined distance causes the actuator to move the mechanical iris into the closed position to inhibit access to the pet food.

According to another one or more embodiments of the present disclosure, an automatically closing pet food system may include at least one collar fob configured for wear by at least one authorized pet and including a transmitter therein; and a food bowl including a main body, a receiver, a mechanical iris, a wireless communication module, at least one sensor, a controller; and pet monitoring software running on a remote device.

The mechanical iris may be disposed at a top of the main body and including an actuator configured to move the mechanical iris between a closed position and an open position, where the closed position covers the opening and inhibits access to the amount of pet food; and the open position uncovers the opening and provides access to the amount of pet food. The actuator may be in communication with the receiver such that receipt of the signal from the transmitter causes the actuator to move the mechanical iris into the open position to provide access to the pet food for the authorized pet and movement of the transmitter past the predetermined distance causes the actuator to move the mechanical iris into the closed position to inhibit access to the pet food.

The wireless communication module, the at least one sensor and the controller may be disposed in the main body. The at least one sensor may be configured to sense each time the mechanical iris has moved into the open position and send sensed data (regarding each time the mechanical iris has moved into the open position) to the controller. The controller may be configured to receive the sensed data from the at least one sensor and use the sensed data to maintain a count of how many times the mechanical iris has moved into the open position. The controller may further be configured to send the count to the pet monitoring software on the remote device via the wireless communication module. Upon receiving the count, the pet monitoring software may then be configured to display the count to a user via the remote device.

According to another embodiment, a method of preventing unauthorized access to a pet food bowl is also disclosed herein. The method may comprise the steps of: providing one or more embodiments of the automatically closing pet food system as above; attaching the at least one transmitter to at least one authorized pet; receiving, by the receiver, a signal from the at least one transmitter when the at least one authorized pet is within a predetermined distance; upon receipt of the signal, causing, by the actuator, the mechanical iris to move into an open position, thereby uncovering the opening and providing access to the amount of pet food; and upon loss of the signal, causing, by the actuator, the mechanical iris to move into a closed position, thereby covering the opening and inhibiting access to the amount of pet food.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, automatically closing pet food system, constructed and operative according to the teachings of the present disclosure.

FIG. 1 is a side perspective view of an automatically closing pet food system in an open position after receiving a signal from a transmitter worn by an authorized pet, according to one or more embodiments embodiment of the disclosure.

FIG. 2 is a side perspective view of the automatically closing pet food system in a closed position after losing the signal from the transmitter worn by the authorized pet, according to one or more embodiments embodiment of the disclosure.

FIG. 3 is a top perspective view of the automatically closing pet food system illustrating a food dish shown including a mechanical iris closure mechanism in an open position, according to one or more embodiments of the present disclosure.

FIG. 4 is a top perspective view of the automatically closing pet food system illustrating the food dish including the mechanical iris closure mechanism in a closed position, according to one or more embodiments of the present disclosure.

FIG. 5 is a top perspective view of the automatically closing pet food system illustrating the food dish including the mechanical iris closure mechanism in the closed position, according to one or more other embodiments of the present disclosure.

FIG. 6 is a plan view of a bottom side of the mechanical iris closure mechanism in a partially open position, according to one or more embodiments of the present disclosure.

FIG. 7 is a plan view of the bottom side of the mechanical iris closure mechanism in the closed position, according to one or more embodiments of the present disclosure.

FIG. 8 is a front view of the transmitter integrated into a collar fob, according to one or more embodiments of the present disclosure.

FIG. 9 is a schematic diagram illustrating inner electronic components of the transmitter and the food bowl to facilitate communication therebetween, according to one or more embodiments of the present disclosure.

FIG. 10 is a front view of the food bowl communicating with a pet monitoring app on a remote device, according to one or more embodiments of the present disclosure.

FIG. 11 is a schematic diagram illustrating inner electronic components of the food bowl to facilitate communication with the pet monitoring app, according to one or more embodiments of the present disclosure.

FIG. 12 is a flow diagram illustrating a method of preventing unauthorized access to a pet food bowl, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an automatically closing pet food system. Generally, the automatically closing pet food system prevents unauthorized access to pet food by providing a transmitter that attaches to an authorized pet, and a receiver located in a food bowl of the automatically closing pet food system. As the authorized pet gets within a predetermined distance of the food bowl, a closure mechanism on the food bowl opens to provide the authorized pet with access to the food in the food bowl. When the authorized pet walks away from the food bowl, the closure mechanism closes to again inhibit access to the food.

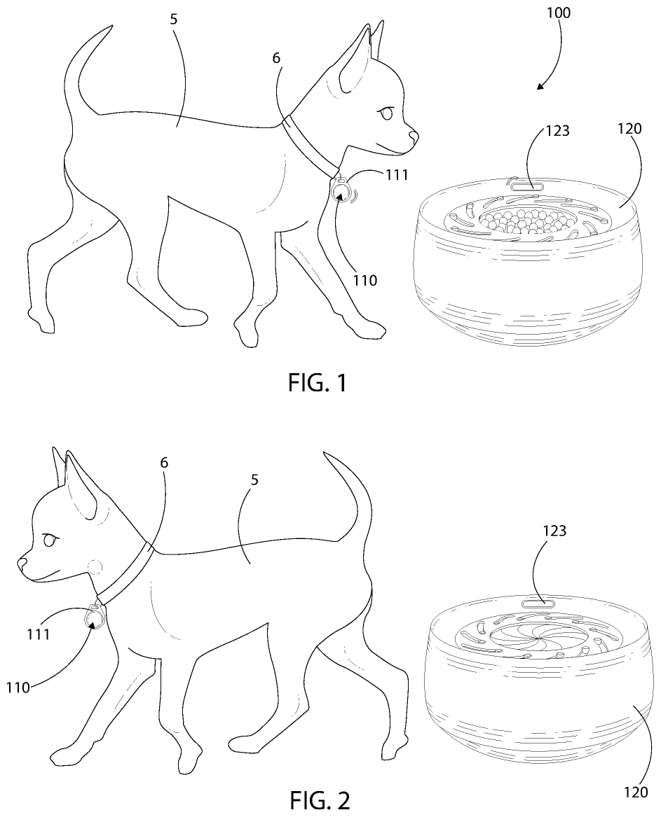

Referring now more specifically to the drawings by numerals of reference, there is shown in FIGS. 1-11, various views of an automatically closing pet food system 100. The automatically closing pet food system 100 may be of particular use to keep unauthorized pet(s) from accessing food in a bowl, which may be desired for a number of reasons. For example, dietary restrictions of an unauthorized pet and/or an authorized pet, overeating of the unauthorized pet, medicated food for the authorized pet, food aggression by the unauthorized pet and/or the authorized pet, food allergies of the unauthorized pet and/or the authorized pet, feeding schedules of the unauthorized pet and/or the authorized pet, or the like.

Referring first to FIGS. 1-2, there is shown the automatically closing pet food system 100 in an in use condition to demonstrate use of the automatically closing pet food system 100. Particularly, the automatically closing pet food system 100 is configured for use by an authorized pet 5 (i.e., the pet allowed to access the particular food in the automatically closing pet food system 100). It should be appreciated that any one automatically closing pet food system 100 may not be limited to use by one sole authorized pet 5—there may be multiple authorized pets 5 able to access one automatically closing pet food system 100.

In a preferred embodiment, the authorized pet 5 may be recognized via the attachment of a transmitter 110 thereto. For example, in some embodiments, the transmitter 110 may be integrated into a collar fob 111 that may be fastened to a collar 6, worn around a neck of the authorized pet 5. As such, in examples including more than one authorized pet 5, a transmitter 110 may be attached to each authorized pet 5.

As shown in FIG. 1, as the authorized pet 5 approaches the automatically closing pet food system 100, a receiver 123 in the automatically closing pet food system 100 receives a signal from the transmitter 110 attached to the authorized pet 5, which causes the automatically closing pet food system 100 to open, enabling the authorized pet 5 to access food therewithin. As shown in FIG. 2, once the authorized pet 5 has finished eating and moves away from the automatically closing pet food system 100, the signal from the transmitter 110 is lost, which causes the automatically closing pet food system 100 to close, preventing access to the food therewithin. As such, any unauthorized pets in the area (e.g., home, shelter, veterinary office, etc.) are unable to access the food.

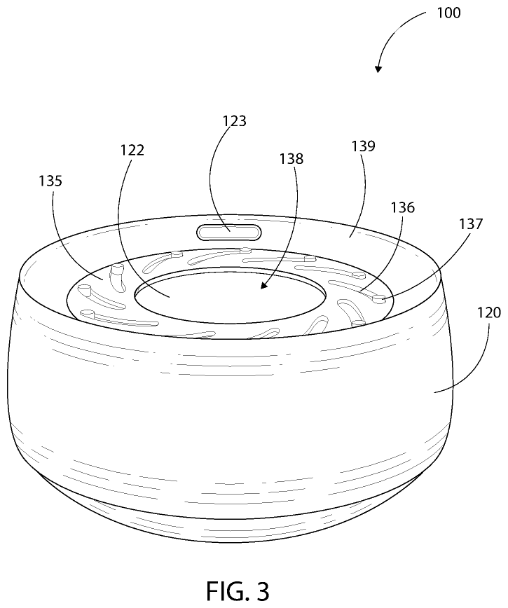

Referring now more specifically to FIGS. 3-5, there are shown perspective views of the automatically closing pet food system 100 in an open position and a closed position. As shown here, the automatically closing pet food system 100 may comprise a food bowl 120 including a main body 121 and a mechanical closure 124. In some embodiments a bottom 119 of the food bowl 120 may include a non-slip material, such as (but not limited to) rubber or silicone, to aid grip of the food bowl 120 on a surface (e.g., a floor). Further, in some embodiments, the bottom 119 of the food bowl 120 may be openable—for example, the bottom 119 of the food bowl 120 may be hinged to the main body 121.

As can be seen in FIG. 3, the main body 121 may include an opening 122 providing access to an interior 138 of the main body 121, which is configured to store an amount of pet food. In some embodiments, a removable bowl insert (not illustrated) may be provided for insertion into the interior 138 of the main body 121. In this embodiment, the removable bowl insert directly stores the amount of pet food, allowing the removable bowl insert to be removed to refill the pet food and clean the removable bowl insert. In some embodiments, the removable bowl insert may be made from (but is not limited to being made from) stainless steel.

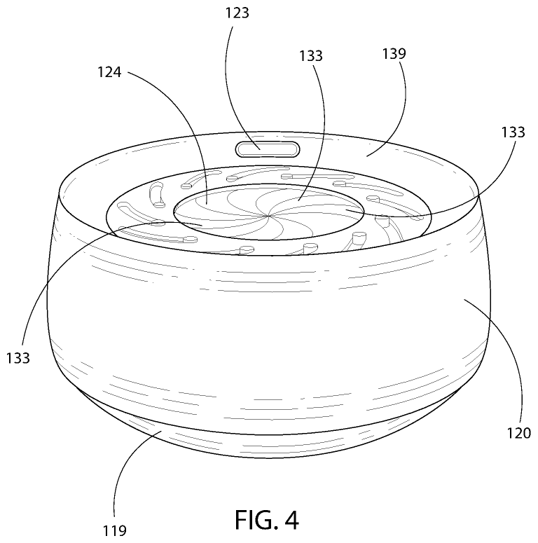

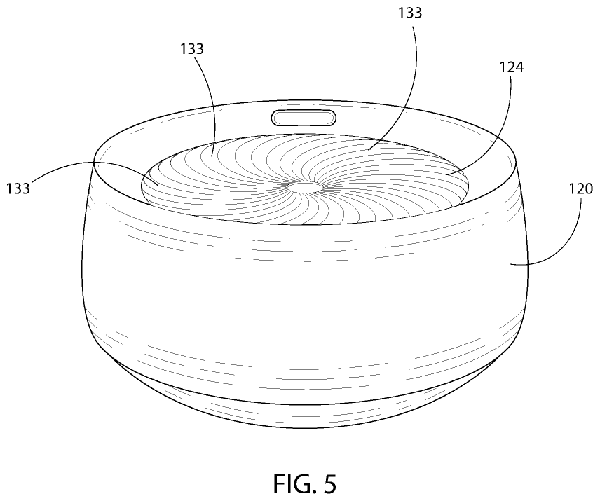

The mechanical closure 124 may be disposed at a top of the main body 121. In some embodiments, the mechanical closure 124 may be removable from the main body 121. Preferably, as shown in FIGS. 3-5, the mechanical closure may include a mechanical iris 124 configured to move between a closed position and an open position. As shown in FIGS. 4-5, the closed position covers the opening 122 of the main body 121 and inhibits access to the amount of pet food. FIG. 4 demonstrates an example mechanical iris 124 according to one or more embodiments of the present invention; and FIG. 5 demonstrates another example mechanical iris 124 according to one or more other embodiments of the present invention. It should be appreciated that the mechanical 124 is not limited to either of the illustrated configurations.

Further, as shown in FIG. 3, the open position uncovers the opening 122 and provides access to the amount of pet food. The closed position may be the ‘neutral’ position of the mechanical iris 124—in that the mechanical iris 124 is usually closed and only opens upon actuation.

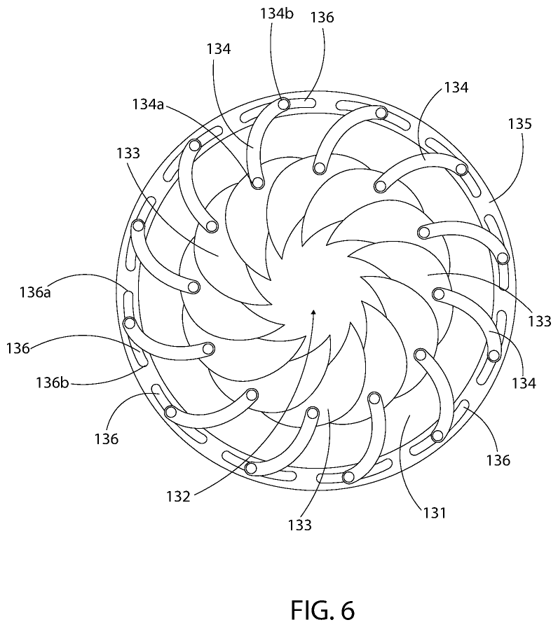

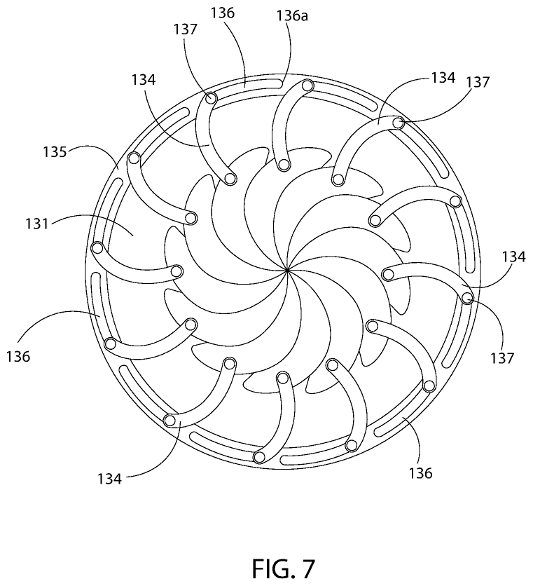

Referring now also to FIGS. 6-7, with refence still to FIGS. 3-5, there are shown plan views of a bottom, or underneath, of the mechanical iris 124, to illustrate the inner components thereof. As shown, the mechanical iris 124 may include a circular plate 131, a plurality of blades 133, and a circumferential plate 135. As above, the mechanical iris 124 is not limited to any particular configuration and as such, the number of blades 133 used and/or their configurations may not be limited. For example, the mechanical iris 124 shown in FIG. 5 includes longer blades 133 and a larger number thereof than the mechanical iris 124 shown in FIGS. 1-5 and FIGS. 6-7 and described herein.

The circular plate 131 may include a plate opening 132 therein which is aligned with the opening 122 in the main body 121 when the mechanical iris 124 is attached thereto (i.e., sharing a central axis). The plate opening 132 in the circular plate 131 particularly defines an opening of the automatically closing pet food system 100 when in use. The plurality of blades 133 may each be attached to an arm 134 at a first end 134a of the arm 134 and the arm 134 may be attached to the circumferential plate 135 at a second end 134b of the arm 134.

The circumferential plate 135 may be attached to the circular plate 131 and configured to rotate in a first plate direction and a second plate direction. Particularly, the circumferential plate 135 may include a plurality of tracks 136 equally spaced therearound and the circular plate 131 may include a plurality of stop members 137 which hold the circumferential plate 135 to the circular plate 131. Particularly, as shown in FIGS. 6-7 (and FIG. 3), each stop member 137 may be configured to engage with one of the plurality of tracks 136.

The stop members 137 also may prevent rotation of the circumferential plate 135 too far in either direction. For example, rotation of the circumferential plate 135 in the first plate direction may stop when the stop members 137 have reached a first end 136 a of the respective track 136, and rotation of the circumferential plate 135 in the second plate direction may stop when the stop members 137 have reached a second end 136b of the respective track 136.

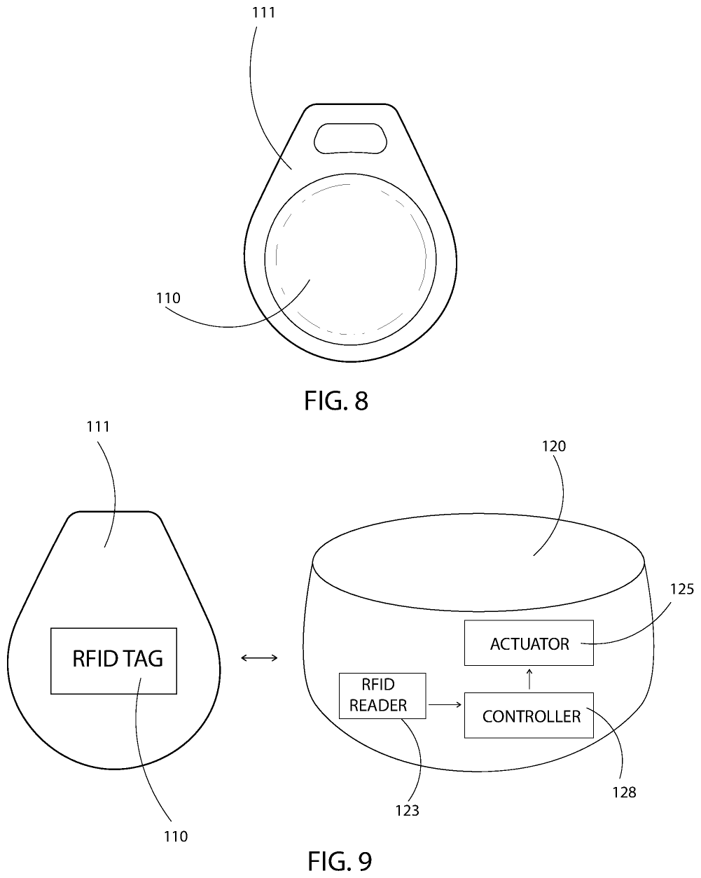

Referring now also to FIGS. 8-9, there are shown various views and schematic diagrams of the various components of the automatically closing pet food system 100 to illustrate their relationships. Particularly, FIG. 8 illustrates a front view of the transmitter 110, which as discussed above may be integrated into a collar fob 111, which in turn may attach to a collar 6 of the authorized pet 5 (FIGS. 1-2). FIG. 9 illustrates a schematic diagram of the transmitter 110 and the food bowl 120 in communication, particularly illustrating the electronic components responsible for facilitating the communication between the transmitter 110 and the food bowl 120.

As above, the transmitter 110 is configured to send a signal to the food bowl 120. As such, the food bowl 120 may include the receiver 123 disposed therein (e.g., at an upper edge 139 of the food bowl 120 as shown in FIGS. 3-4) and configured to receive a signal from the transmitter 110 when within a predetermined distance.

In some embodiments, the distance may be (but is not limited to) 12 inches. As such, when the authorized pet 5 (when wearing the transmitter 110) gets within 12 inches of the automatically closing pet food system 100, the mechanical iris 124 opens; and when the authorized pet 5 moves further than 12 inches away from the automatically closing pet food system 100, the mechanical iris 124 closes. In some embodiments, the transmitter 110 and the receiver 123 may utilize (but are not limited to) Radio Frequency Identification (RFID). As such, the transmitter 110 may be an RFID tag affording a unique identity to the authorized pet 5; and the receiver 123 may be an RFID reader configured to read the unique identity. However, other means of communicating signals may also be contemplated.

An actuator 125 may be provided in communication with the receiver 123. For example, the actuator 125 may be in communication with the receiver 123 via a controller 128. The controller 128 may be a simple circuit or a microcontroller or processor configured to perform more sophisticated commands.

As shown in FIG. 9, the actuator 125 may be in communication with the receiver 123 such that upon receipt of the signal from the transmitter 110 (at the receiver 123), the actuator 125 causes the mechanical iris 124 to move into the open position to provide access to the pet food for the authorized pet 5. Particularly, in some embodiments, the actuator 125 may be connected to the circumferential plate 135 and configured to, upon receipt of the signal from the transmitter 110, cause rotation of the circumferential plate 135 in the first plate direction, in turn causing movement of each arm 134 in a first arm direction and moving the plurality of blades 133 into the open position.

Similarly, movement of the transmitter 110 past the predetermined distance may cause the actuator 125 to move the mechanical iris 124 into the closed position to inhibit access to the pet food. Particularly, movement of the transmitter 110 past the predetermined distance (resulting in loss of signal from the transmitter 110) may cause rotation of the circumferential plate 135 in a second plate direction, in turn causing movement of each arm 134 in a second arm direction and moving the plurality of blades 133 into the closed position.

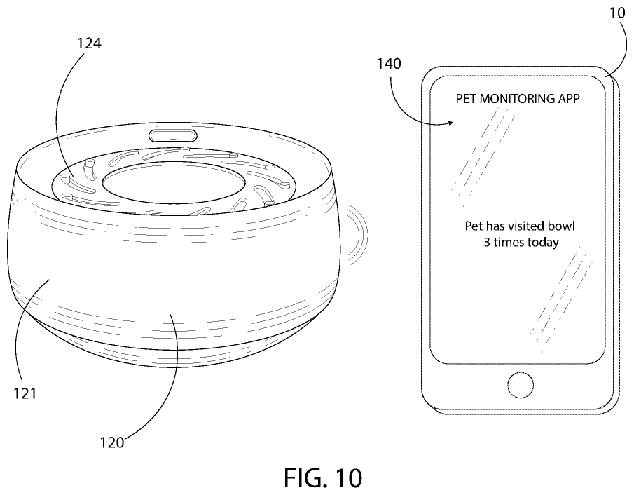

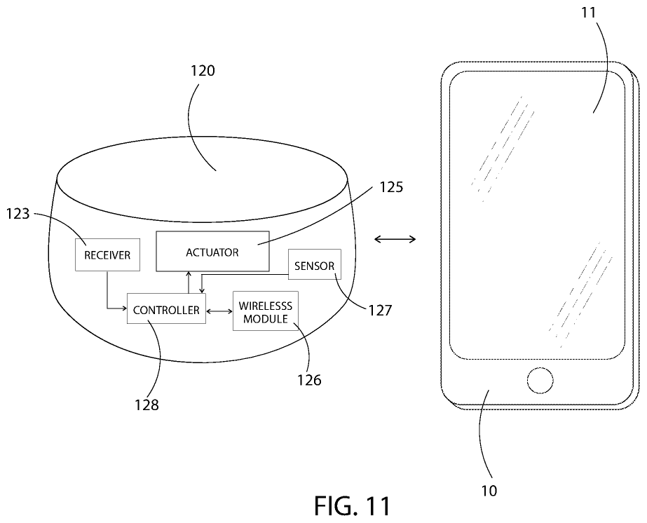

Referring now to FIGS. 10-11, there is shown the automatically closing pet food system 100 and pet monitoring software 140 running on a remote device 10. For example, as shown in these figures, the remote device 10 may be a smartphone and the pet monitoring software 140 may be a smartphone application. It may however be contemplated that the remote device 10 is any device that is able to run the pet monitoring software 140 and includes a display 11 and a device wireless communication module (not illustrated).

The pet monitoring software 140 may enable users to monitor use of the automatically closing pet food system 100. Particularly, the automatically closing pet food system 100 may be configured to determine the amount of times the authorized pet 5 has eaten and send this information to the pet monitoring software 140 for access by a user (such as an owner) on the remote device 10.

For example, the automatically closing pet food system 100 may, in some embodiments, include at least one sensor 127 to sense each time the mechanical iris has moved into the open position. In some examples, the at least one sensor 127 may include (but is not limited to) one or more proximity sensors, one or more motion sensors, one or more magnetic switches, one or more photoelectric sensors, one or more limit switches, or the like. It should be appreciated that this list is not exhaustive, nor is the at least one sensor 127 limited to any of the examples listed here.

Further, in this embodiment, the automatically closing pet food system 100 may include a wireless communication module 126 (e.g., BLUETOOTH®) able to send information to the pet monitoring software 140 on the remote device 10. The at least one sensor 127 may send sensed data (pertaining to [at least] each time the mechanical iris has moved into the open position) to the controller 128. The controller 128 may be configured to receive the sensed data from the at least one sensor 127 and use the sensed data to maintain a count of how many times the mechanical iris has moved into the open position, thereby establishing how many times the authorized pet 5 has eaten. For example, each time the authorized pet 5 eats, the mechanical iris 124 opens—the at least one sensor 127 then sends this sensed data to the controller 128, and the controller 128 can then update the count accordingly. The controller 128 may, in some embodiments, store the count on an internal memory (not illustrated).

The controller 128 may also be configured to send the count to the pet monitoring software 140 (via the wireless communication module 126). The user may then easily access the pet monitoring software 140 to view the count via the display 11 on the remote device 10. The count may be displayed to the user via push notifications and/or may be accessed manually (i.e., by the user opening the pet monitoring software 140 on the remote device 10).

A power source is provided (not illustrated) to provide power to electronic components of the food bowl 120. For example, the power source may include a built-in battery and/or may include an AC power port. Further, the food bowl 120 may include a power switch (not illustrated), which may disposed about an exterior thereof, enabling the power supply to be selectively turned on and off.

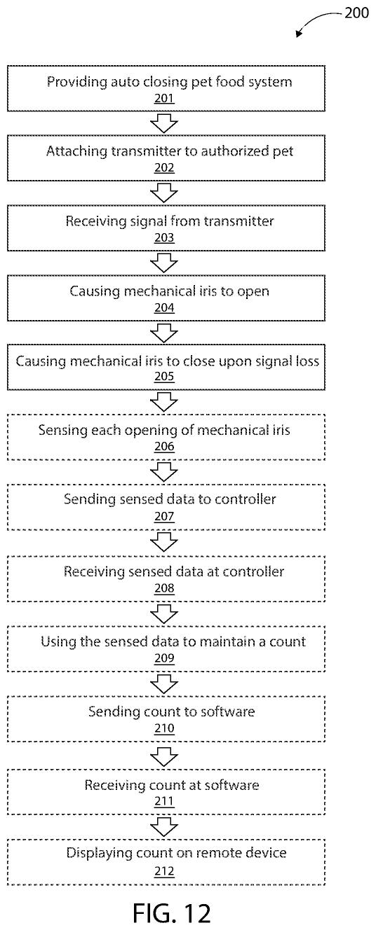

Referring now to FIG. 12 showing a flow diagram illustrating a method of preventing unauthorized access to a pet food bowl (“method” 200), according to an embodiment of the present disclosure. In particular, the method 200 may include one or more components or features of the automatically closing pet food system 100 as described above. As illustrated, the method 200 may include the steps of: step one 201, providing the automatically closing pet food system as above; step two 202, attaching at least one transmitter to at least one authorized pet; step three 203, receiving, by the receiver, a signal from the at least one transmitter when the at least one authorized pet is within a predetermined distance; step four 204, upon receipt of the signal, causing, by the actuator, the mechanical iris to move into an open position, thereby uncovering the opening and providing access to the amount of pet food; and step five 205, upon loss of the signal, causing, by the actuator, the mechanical iris to move into a closed position, thereby covering the opening and inhibiting access to the amount of pet food.

In embodiments wherein the automatically closing pet food system further comprises the pet monitoring software, the method may further comprise the steps of: step six 206, sensing, by the at least one sensor, each time the mechanical iris has moved into the open position; step seven 207, sending, by the at least one sensor, sensed data (regarding said each time the mechanical iris has moved into the open position) to the controller; step eight 208, receiving, by the controller, sensed data from the at least one sensor; step nine 209, using, by the controller, the sensed data to maintain a count of how many times the mechanical iris has moved into the open position; step ten 210, sending, by the controller, the count to the pet monitoring software of the remote device via the wireless communication module; step eleven 211, receiving, by the pet monitoring software, the count; and step twelve 212, displaying, via a display on the remote device, the count to a user of the remote device.

It should be noted that certain steps are optional and may not be implemented in all cases. Optional steps are illustrated using dotted lines in FIG. 12 so as to distinguish them from the other steps of method 200. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods are taught herein.

It should be understood by one of skill in the art that the disclosed invention is described here in a few exemplary embodiments of many. No particular terminology or description should be considered limiting on the disclosure or the scope of any claims issuing therefrom.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the relevant patent office(s) and the public generally, and especially the scientist, engineers and practitioners in the art who are not familiar with patent or legal terms or phraseology, to determine quickly from a cursory inspection the nature and essence of the technical disclosure of the application.

What is claimed is:

1. An automatically closing pet food system comprising:
at least one transmitter configured for attachment to at least one authorized pet; and
a food bowl including:
a main body having an opening providing access to an interior of the main body, the interior configured to store an amount of pet food;
a receiver disposed in the main body and configured to receive a signal from the transmitter when within a predetermined distance; and
a mechanical iris disposed at a top of the main body, the mechanical iris including an actuator configured to move the mechanical iris between a closed position and an open position, the closed position covering the opening and inhibiting access to the amount of pet food, the open position uncovering the opening and providing access to the amount of pet food; and
wherein the actuator is in communication with the receiver such that receipt of the signal from the at least one transmitter causes the actuator to move the mechanical iris into the open position to provide access to the pet food for the authorized pet, and movement of the transmitter past the predetermined distance causes the actuator to move the mechanical iris into the closed position to inhibit access to the pet food.

2. The automatically closing pet food system of claim 1, further comprising pet monitoring software running on a remote device.

3. The automatically closing pet food system of claim 2, wherein the food bowl further comprises a wireless communication module configured for communication with the pet monitoring software.

4. The automatically closing pet food system of claim 3, wherein the food bowl further comprises at least one sensor for sensing each time the mechanical iris has moved into the open position.

5. The automatically closing pet food system of claim 4, wherein the food bowl further comprises a controller in communication with the at least one sensor and the wireless communication module;
wherein the controller is configured receive sensed data from the at least one sensor and use the sensed data to maintain a count of how many times the mechanical iris has moved into the open position;
wherein the controller is further configured to send the count to the pet monitoring software on the remote device via the wireless communication module;
wherein the pet monitoring software is configured to receive the count; and
wherein the pet monitoring software is further configured to display the count to a user of the remote device.

6. The automatically closing pet food system of claim 1, wherein the at least one transmitter is integrated into at least one collar fob.

7. The automatically closing pet food system of claim 6, wherein the receiver is disposed at an upper edge of the food bowl.

8. The automatically closing pet food system of claim 7, wherein the at least one transmitter and the receiver utilize Radio Frequency Identification.

9. The automatically closing pet food system of claim 8, wherein the mechanical iris includes a circular plate having a plate opening therein and a plurality of blades each attached to an arm at a first end of the arm, the arm being attached to a circumferential plate at a second end of the arm.

10. The automatically closing pet food system of claim 9, wherein the actuator is connected to the circumferential plate and configured to, upon receipt of the signal from the at least one transmitter at the receiver, cause rotation of the circumferential plate in a first plate direction, in turn causing movement of each arm in a first arm direction and moving the plurality of blades into the open position; and
wherein movement of the at least one transmitter past the predetermined distance causes loss of the signal at the receiver, causing the actuator to rotate the circumferential plate in a second plate direction, in turn causing movement of each arm in a second arm direction and moving the plurality of blades into the closed position.

11. The automatically closing pet food system of claim 10, wherein the predetermined distance is 12 inches.

12. The automatically closing pet food system of claim 11, wherein the circumferential plate includes a plurality of tracks equally spaced therearound, wherein the circular plate includes a plurality of stop members, each stop member configured to engage with one of the plurality of tracks, wherein rotation of the circumferential plate in the first plate direction stops when the stop members have reached a first end of the respective track, and wherein rotation of the circumferential plate in the second plate direction stops when the stop members have reached a second end of the respective track.

13. An automatically closing pet food system comprising:
at least one collar fob configured for wear by at least one authorized pet, the at least one collar fob including a transmitter; and
a food bowl including:
a main body having an opening providing access to an interior of the main body, the interior configured to store an amount of pet food;
a receiver disposed in the main body and configured to receive a signal from the transmitter when within a predetermined distance;
a mechanical iris disposed at a top of the main body, the mechanical iris including an actuator configured to move the mechanical iris between a closed position and an open position, the closed position covering the opening and inhibiting access to the amount of pet food, the open position uncovering the opening and providing access to the amount of pet food;
wherein the actuator is in communication with the receiver such that receipt of the signal from the at least one transmitter causes the actuator to move the mechanical iris into the open position to provide access to the pet food for the authorized pet, and movement of the transmitter past the predetermined distance causes the actuator to move the mechanical iris into the closed position to inhibit access to the pet food;
a wireless communication module disposed in the main body;
at least one sensor disposed in the main body and configured to sense each time the mechanical iris has moved into the open position; and
a controller disposed in the main body and in communication with the at least one sensor and the wireless communication module; and
pet monitoring software running on a remote device;
wherein the at least one sensor is configured to send sensed data, regarding said each time the mechanical iris has moved into the open position, to the controller;
wherein the controller is configured to receive the sensed data from the at least one sensor and use the sensed data to maintain a count of how many times the mechanical iris has moved into the open position;
wherein the controller is further configured to send the count to pet monitoring software on the remote device via the wireless communication module;
wherein the pet monitoring software is configured to receive the count; and
wherein the pet monitoring software is configured to display the count to a user via the remote device.

14. The automatically closing pet food system of claim 13, wherein the transmitter and the receiver utilize Radio Frequency Identification.

15. The automatically closing pet food system of claim 14, wherein the mechanical iris includes a circular plate having a plate opening therein, and a plurality of blades each attached to an arm at a first end of the arm, the arm being attached to a circumferential plate at a second end of the arm.

16. The automatically closing pet food system of claim 15, wherein the actuator is connected to the circumferential plate and configured to, upon receipt of the signal from the transmitter at the receiver, cause rotation of the circumferential plate in a first plate direction, in turn causing movement of each arm in a first arm direction and moving the plurality of blades into the open position; and
wherein movement of the transmitter past the predetermined distance causes loss of the signal at the receiver, causing the actuator to rotate the circumferential plate in a second plate direction, in turn causing movement of each arm in a second arm direction and moving the plurality of blades into the closed position.

17. The automatically closing pet food system of claim 16, wherein the predetermined distance is 12 inches.

18. The automatically closing pet food system of claim 17, wherein the circumferential plate includes a plurality of tracks equally spaced therearound, wherein the circular plate includes a plurality of stop members, each stop member configured to engage with one of the plurality of tracks, wherein rotation of the circumferential plate in the first plate direction stops when the stop members have reached a first end of the respective track, and wherein rotation of the circumferential plate in the second plate direction stops when the stop members have reached a second end of the respective track.

19. A method of preventing unauthorized access to a pet food bowl, comprising:
providing an automatically closing pet food system including:
at least one transmitter;
a food dish having:
a main body having an opening providing access to an interior of the main body, the interior configured to store an amount of pet food;
a receiver disposed in the main body; and
a mechanical iris disposed at a top of the main body, the mechanical iris including an actuator;
attaching the at least one transmitter to at least one authorized pet;
receiving, by the receiver, a signal from the transmitter when the at least one authorized pet is within a predetermined distance;
upon receipt of the signal, causing, by the actuator, the mechanical iris to move into an open position, thereby uncovering the opening and providing access to the amount of pet food; and
upon loss of the signal, causing, by the actuator, the mechanical iris to move into a closed position, thereby covering the opening and inhibiting access to the amount of pet food.

20. The method of claim 19, wherein the automatically closing pet food system further comprises pet monitoring software running on a remote device;
wherein the food dish further comprises:
a wireless communication module disposed in the main body;
at least one sensor disposed in the main body; and
a controller disposed in the main body and in communication with the at least one sensor and the wireless communication module; and
wherein the method further comprises the steps of:
sensing, by the at least one sensor, each time the mechanical iris has moved into the open position;
sending, by the at least one sensor, sensed data regarding said each time the mechanical iris has moved into the open position, to the controller;
receiving, by the controller, sensed data from the at least one sensor;
using, by the controller, the sensed data to maintain a count of how many times the mechanical iris has moved into the open position;
sending, by the controller, the count to the pet monitoring software on the remote device via the wireless communication module;
receiving, by the pet monitoring software, the count; and
displaying, via a display on the remote device, the count to a user of the remote device.
